(19) United States
(12) Patent Application Publication
(10) Pub. No.: US 2008/0315776 A1
(43) Pub. Date: Dec. 25, 2008

(54) Traffic signal lights showing dynamic patterns, particularly as are interposed on continuous illumination

(76) Inventor: Renato Martinez Openiano, Chula Vista, CA (US)

Correspondence Address: William C. Fuess;Suite 2G, 10951 Sorrento Valley Road, San Diego, CA, 92121-1613, US

(21) Appl. No.: 12/214,987

(22) Filed: Jun. 23, 2008

Related U.S. Application Data
(60) Provisional application No. 60/936,878, filed on Jun. 22, 2007.

(51) Int. Cl. H05B 37/02; H05B 37/00

(52) U.S. Cl. 315/185 R; 315/360

(57) ABSTRACT

A traffic control signal light presents (1) a first, constant, light emission preferably from arrayed first LED light sources, in accompaniment with (2) a second light emission that is in any of time, hue, pitch (frequency), chroma and, most preferably, space, preferably from arrayed second LED light sources interspersed with the first LED light sources. The variable second light emission is preferably 8-10 Hz, and may cause Brücke-Bartley phenomenon, making that the composite light stimulates the combined human visual and nervous systems, and is all but impossible to miss or to ignore.

### REFERENCE TO RELATED APPLICATIONS

The present application is related to, and claims benefit of priority of, U.S. Provisional Patent applications Ser. No. 60/936,878 filed Jun. 22, 2007. for “Traffic signal lights with interposing light patterns”. The provisional patent applications is in the name of the selfsame inventor of the present application.

### BACKGROUND OF THE INVENTION

1. Field of the Invention

The present invention generally concerns traffic signal and control lights.

The present invention particularly concerns traffic signal and control lights that induce improved attentiveness in drivers viewing the same be present patterns.

2. Background of the Invention

It is known that lights, and multiple lights, can be manipulated in various manners so as to affect the human visual system, including so as to induce disorientation and/or nausea.

2.1 Use of Variable Lights in Warfare

In the article “Secret Strobe light Weapons of World War II” by David Hambling appearing in the May 17, 2008, issue of WIRED magazine, it is explained that the disorienting power of strobing weapons that use flickering lights to subdue criminals and insurgents was discovered at least as early as World War I.

A secret weapon in that war was the Canal Defence Light—a powerful searchlight mounted on a tank, with a shutter allowing it to flicker six times a second. The 13-million candlepower searchlight was intended as means of illuminating the battlefield and dazzling the enemy, described in a fascinating article on the CDL Tanks of Lowther castle.

The angle of the beam dispersion was 19 degrees which meant that if the CDL tanks were placed 30 yards apart in line abreast, the first intersection of light fell about 90 yards ahead and at 1000 yards the beam was 340 yards wide by 35 feet high. This formed triangles of darkness between and in front of the CDL's into which could be introduced normal fighting tanks, flame-throwing Churchill Crocodiles and infantry.

A further refinement was the ability to flicker the light. On the order given for ‘Scatter’, an armour plated shutter was electrically oscillitated back and forward at about six times a second. When first produced it was thought that this flicker effect (similar to the modern disco strobe lights) would have a damaging effect on the eyes of any observer and might cause temporary blindness.

It was the flickering aspect which made the CDL special. The makes found that when it was employed, it was impossible to locate the vehicle accurately. In one test a CDL-equipped vehicle was driven towards a 25-pounder anti-tank gun; even as it closed from 2000 yards to 500 yards the gunners (firing practice rounds, one assumes) were unable to hit the tank. When asked to draw the route taken by the CDL tank, the observers drew a straight line, while in fact the tank had been crossing the range from side to side.

Spraying the area with machine-gun fire would not work either; the armoured reflector of the searchlight kept working even after being hit repeatedly.

Although the CDL did not have the kind of disabling effect that the light-based personnel immobilization device being developed by Peak Beam for the US Army, the type of disorientation seems quite similar. If it had been used at much closer range then more dramatic effects—dizziness, loss of balance and the infamous nausea—might also have been observed. However, with its mechanical shutter the technology was much more primitive than the strobing Xenon light developed by Peak Beam which produces a ‘squarer’ pulse and is significantly more effective than earlier strobes.

Over three hundred CDLs were built—using Matilda, Churchill and Grant tanks—and might have played a major role after D-Day, but instead, they remained unused. There seem to have been two reasons for this. One the one hand, the power or the CDL was kept extremely secret: “Even the Generals who should have used it did not know what the tank could do,” complained its inventor, Marcel Mitzakis. And those that had heard of it had trouble believing at a simple flickering light could have any effect, and preferred to rely on proven weapons. Major-General JFC Fuller, the man credited with developing modern armored warfare in the 1920's, was one of the few who appreciated what the CDl might have achieved

Another use of flickering lights in WWI was the proposal by Jasper Maskelyne, a stage magician employed by the British military. (A very colorful account of Maskelyne's role is given in the book The War Magician—reading it you might think he won the war single-handed.) The magician was set the task of making the Suez Canal invisible to enemy bombers. When the idea of constructing an illusion using mirrors was rejected as impractical, another plan was formulated, as this site on Maskelyne describes:

Maskelyne came up with the unorthodox idea of constructing 21 ‘dazzle lights’ along the length of the Canal. These powerful searchlights, containing 24 different spinning beams, projected a swirling, cartwheeling confusion of light up to nine miles into the sky. A barrage of light to confuse and blind the enemy bombers, which Maskelyne dubbed Whirling Spray.

Fisher claims that this radical defensive shield of light was highly effective and was a major reason why the Suez Canal remained open for the duration of the war.

However, in spite of claims on the book, they were never actually built, although a prototype was once tested. Is the power of strobing lights just an illusion based on hype, like Maskelyne's whirling spray? Or a significant new weapon which will be ignored or shelved because people are either ignorant of it or don't believe . . . ?

2.2 Vomit lights do not strictly exist, but the human nervous system can nonetheless be powerfully affected by pulsating lights

Also in WIRED magazine, the article Can Strobe Weapons Really Make You Puke? also by David Hambling appearing May 14, 2008. surveyed more recent articles on “nausea lights.

A feature in New Scientist magazine on non-lethal strobe devices discussed new arms relying on flashing lights, like the “LED Incapacitator,” Peak Beam's searchlight-based “Immobilization Device,” and Nanohmics' non-pyrotechnic stun grenade.

There is a great deal of debate over how well these devices work and what their effects are. That's because the military's tests have traditionally been more concerned with environmental health. But now, the military is sponsoring a whole range of tests which go well beyond previous studies.

In the meantime, there are some myths we can clear up pretty quickly:

“It makes you vomit,” as popularized in by Fox News' story, Flashlight Weapon Makes Targets Throw Up. Although disorientation, dizziness and nausea were quoted by all the designers as common effects, nausea is not the same as throwing up. “I don't think we've had anyone actually be sick”, says Bob Lieberman, CEO of Intelligent Optics, which makes the LED Incapacitator. In fact, nausea is not one of the immediate effects, but is more likely to occur afterwards—it doesn't really contribute to the weapon's effectiveness. Lieberman is philosophical about the ‘puke saber’ stories which are passed around the media, judging that the exposure is worth it. “We're grateful that people have taken such an interest,” he says.

“It'll make you have an epileptic fit.” People with photosensitive epilepsy (around four per thousand of the population) may have seizures triggered by flashing lights. But it turns out that the frequencies which trigger seizures can be avoided.

“Our products are engineered around this situation as to not endanger people with this condition,” says Will Harcourt, Peak Beam's Director of Sales. Prof. Ley Sander, Professor of Neurology and Clinical Epilepsy at the Institute of Neurology of University College London, says that strobe devices are not be a risk to photosensitive epileptics if they have a pulse rate above 25 Hz.

“If you shut your eyes it makes the weapon useless.” This one amuses everyone working in the field. If you close your eyes you can't run away, you can't fight back, aim a weapon or effectively resist arrest. You have immobilized yourself and made yourself helpless, which is exactly what the non-lethal weapon-makers have in mind. “If they close their eyes,” says Lieberman, “then I've got 'em.”

He sees the LED Incapacitator as being close to the lowest rung of the ladder of force. It may not subdue a suspect every time, but even if it is effective some of the time and prevents officers from having to use a Taser or a firearm then it will be well worthwhile.

The new generation of strobe devices are lightweight, cheap and have an unlimited supply of ammo. Within a few years they could be everywhere—small ones in the hands of police, larger versions mounted on vehicles or drones. The Peak Beam Immobilizer is being mounted on the Vigilante, an unmanned helicopter.

“Testing has also been conducted on our strobe against on-coming vehicles. [The testing organization] rated our Maxa Beam as the most effective non-lethal weapon against drivers that they have ever tested,” says Harcourt.

If they work as advertised, this could be the biggest advance in nonlethals since tear gas.

.3 Sill Other Articles

Still other articles appearing in WIRED magazine entitled “Navy Researching Vomit Beam:, “Puke Ray Hits the Small Screen”, “DHS Readies the ‘Sick Stick’, “Puke Ray, Courtesy of DHS”, “Puke Ray: Coming Soon to a City Near You”, “I Was a Sonic Blaster Guinea Pig Sons of Vomit Beam”, “New Robo-Weapon: Paralyzing Floodlight” and “Light+Sound=New Weapon” make quite clear that the effect of certain moving and pulsating lights upon the human vision and nervous systems is not conjecture, but fact.

### SUMMARY OF THE INVENTION

The present invention contemplates lights, particularly for use in traffic control and more particularly LED-type traffic “stop” lights, that are highly visible, and difficult to ignore, by drivers not because the lights are large and/or bright—although they often are both—but because the lights produce displays that intentionally and inherently interact with the human visual and/or nervous systems, making the lights extremely difficult—essentially impossible—to overlook or to ignore in the driver's full field of view.

In one of its aspects the present invention is embodied in a light having from time to time and at times (1) a first, constant, light emission—such as, by way of example, the “red” or “yellow” or “green” of a standard traffic “stop” light—accompanied by (2) a second light emission that is variable temporally, and/or spatially, and/or in any of hue, pitch (frequency) or chroma. In simple terms, the light in accordance with the invention has a (1) steady state component, and (2) a variable component.

The variable, second, light emission is preferably spatially variable. It is more preferably spatially variable with circular symmetry, either radial (as with a spinning pointer) or more preferably axial (as with successively illuminated concentric rings).

The technology used to produce each component may be the same or different. The same technology is preferably used for both the steady state and variable components, and more preferably both the steady state and the variable components are produced by arrays of light-emitting diodes (LEDs).

Functionally, the illuminating lights produced by lights in accordance with the present invention can appear “weird”; often being not entirely pleasing but sometimes memorable. Since the lights are commonly used in traffic control and hazard alerting—and not for advertising or attracting customers—the arresting character of the lights is as desired. Namely, it is more important that the lights should be visually distinct and even memorable—as may optionally become associated in drivers' minds with a certain traffic directive of type of traffic hazard—than that the lights should be any of restful, inconspicuous, pleasing or attractive.

In one preferred embodiment the lights consist of arrayed substantially-point light sources, such as the arrayed LEDs of a modern traffic light, operated so that, during “ON” periods, (1) some of the point sources, or LEDs, remain constantly on while (2) others of the arrayed LED point light sources are selectively illuminated. This selective illumination is preferably spatially so, and more preferably in a regular pattern that denotes motion, most preferably a rotary motion (with radial symmetry) or a sunburst (with axial symmetry). For example, any of the round yellow or green and, mos preferably red (and any still further colors) emission areas of an LED traffic light are, when periodically energized, preferably operated so that some of the arrayed LEDs remain constantly on while others are sequentially illuminated in time and in space so as to give the appearance of (1) rotation or, more preferably, (2) concentric rings expanding from small to large in an endless cycle. The less-preferred rotation may be as (1) one or more bidirectional pointers like as the hand(s)of a clock, (2) a rotating plate with two or more contacting hemispheres or sectors, or (3) a rotating pattern, such as the classic ying and yang symbol. Still other, less preferred, patterned effect(s) are possible, including linear and/or stochastic effects such as when a brighter (or darker) bar or line sweeps from left to right (or right to left), or top to bottom (or bottom to top) across the face of the light source. The light source is in all cases visually dynamic, and this dynamic taken alone, and at any detectable frequency below about 76 Hertz, or the flicker fusion frequency of the human eye, is hard to miss and harder still to ignore.

However, the present invention further contemplates making the traffic signal lights all but impossible to ignore. The variable components of the lights—a rotating pattern in the above example—is most preferably timed with a cycle period of some 8-10 seconds—precisely that period that is empirically most disturbing to the average human visual and nervous systems. Thus variable illumination of traffic signal lights in accordance with the present invention is thus in part patterned on results from research in illumination done primarily in support of warfare, Accordingly, traffic signal lighting in accordance with the present invention can seem aggressive and/or mean—insofar as these adjectives may even be suitably applied to something so abstract as is light illumination.

Resultantly to potentially inducing a very mild form of the Brücke-Bartley phenomenon (discussed further later), the appearance of lights in accordance with the present invention may make the use of same on every color of every common traffic “stop” light to be overkill. However, lighting and lights in accordance with the present invention may certainly be employed on, preferably, (1) red and (2) the yellow lens of a common three-color traffic stop light. To this end lighting control in accordance with the present invention may be retrofit as a kit to existing LED traffic lights. This lighting control in accordance with the present invention might be employed on traffic stip lights at intersections where an excess of collisions seem to occur, or in hazardous highway regions such as construction zones.

The motoring public will not only clearly see and distinguish traffic lights in accordance with the present invention (possibly even feeling modestly “assaulted’ by such lights), but soon comes to realize—in a subconscious and deep-seated manner which no hazard warning sign sees to convey—that the variable signals of the present invention mark seriously hazardous situations and locations. Although not supported by any neurological research of which the inventor is aware, it is as if traffic signals in accordance with the present invention “tickle the reptilian brain”. The strong response of the visual and/or nervous systems of an average driver—as is desired—may perhaps be demonstrated by an experiment. A foot runner is timed sprinting variously towards (1) a simple sign reading “CAUTION; HAZARD AHEAD” or (2) a variable signal light in accordance with the present invention. By all reason the signal and sign should be the same, there should be no effect at all upon a runner, and the recorded times should be equal. But it is believed to be harder to run at “full tilt” towards a variable light in accordance with the present invention even when the runner knows that it is safe, and perfectly understands the experiment being performed. It is as if our brains inhibit a consciously directed motion of our bodies towards a signal that our subconscious senses to be hazardous and/or hostile. (Indeed, signals in accordance with the present invention are believed to be capable of slowing traffic so much so as to become counterproductive, and should to that extent be used in moderation and with prudence). It is perhaps the same phenomena that makes persons loath to jump off a cliff even when they know that to do so is harmless, and safe.

Continuing with the summary explanation of the present invention, the aforementioned common, prior art, LED traffic light may be located in visually very complex, bright and/or confusing environment, and quite simply be hard to (1) spot (visually acquire), and (2) keep track of even once spotted. In use at an intersection for traffic control, such a traffic light visibility problem might manifest as vehicle drivers not seeing the light or its changes, and proceeding through the intersection on yellow or on red. This failing to realize positive traffic control hazards both (1) accidents, and/or, (2) that drivers in stopped vehicles who do not notice the change of the light from red to green and delay starting across the intersection, thus delaying the flow of traffic.

The overlay of a temporally variable pattern onto a constant display in accordance with the present invention enhances the visibility of the traffic stop light, making it much easier to acquire and re-acquire. It thus has the possibly unexpected effect of making traffic run faster even while the signal-controlled intersection is safer.

However, and as partially explained above, the basic method and apparatus of the present invention for control and signal lights can be extended much, much further, so as to realize lights that are effectively impossible to ignore,

In this case the light exercises causes Brücke-Bartley phenomenon—named for Samuel Howard Bartley and Ernst Wilhelm Ritter von Brücke—to occur in all humans who view it. In this phenomenon related to the Broca-Sulzer effect the light produces the sensation of glare in response to successive stimuli at frequencies just below the critical fusion point. When the frequency is gradually lowered below the CFF (critical flicker fusion), the effective, or apparent, brightness of the light to a viewer thereof begins to rise. This apparent brightness reaches a value equal to that of the light when uninterrupted, or constantly “ON”, and even transcends this apparent brightness, reaching a maximum when the flash rate is about 8 to 10 Hz.

However, something else is going on, as evidenced by the fact that prolonged exposure to lights so operated can induce epileptic seizures in some persons. A light so operated can make an observer's “skin crawl”, and is effectively impossible to ignore. The question becomes not as to whether drivers are paying appropriate attention to a control or signal light so operated, but whether they are paying proper attention to anything else, such as the traffic ahead.

One reasonable use for such a compelling operational mode—which can normally be entered by a signal or traffic light controller simply by a switch actuation or a control sign received by wire or wirelessly—is in the event of a dire emergency. An ambulance might invoke such an extreme, and powerful, control mode if stuck in traffic while requiring the immediate attention and cooperation of surrounding drivers and vehicles. However, it is believed to be most appropriate that such mode should be entered only in time of widespread emergency, such as unsafe highway and/or bridge conditions attendant on an earthquake. Signals so operated can be extremely unsettling, and, ultimately, irritating but are, as previously stated, all but impossible to ignore.

These and other aspects and attributes of the invention will become increasingly clear upon reference to the following drawings and accompanying specification

### BRIEF DESCRIPTION OF THE DRAWINGS

FIG. 1 is a front plan view of a prior art traffic light in accordance with the present invention.

FIG. 2 is a front plan view of the preferred embodiment of a traffic light in accordance with the present invention, showing additional, interspersed, arrayed LEDs over the prior art light previously seen in FIG. 1.

FIG. 3 is a rear plan view of the preferred embodiment of a traffic light in accordance with the present invention previously seen in FIG. 2.

FIG. 3 is a block electrical schematic diagram of an exemplary traffic light in accordance with the present invention, previously seen in FIGS. 2 and 3.

FIG. 5, consisting of FIGS. 5a through 5c, show possible patterns appearing on an exemplary traffic signal light in accordance with the present invention.

### DESCRIPTION OF THE PREFERRED EMBODIMENT

The subject of this invention is a traffic signal light assembly preferably comprised of a housing, a first LED light array of multiple constantly illuminated LEDs interposed with a second light array of periodically illuminated LEDs, a front lens cover, connection to a source of power, and a multi-circuit light sequencing controller, as shown in the figures.

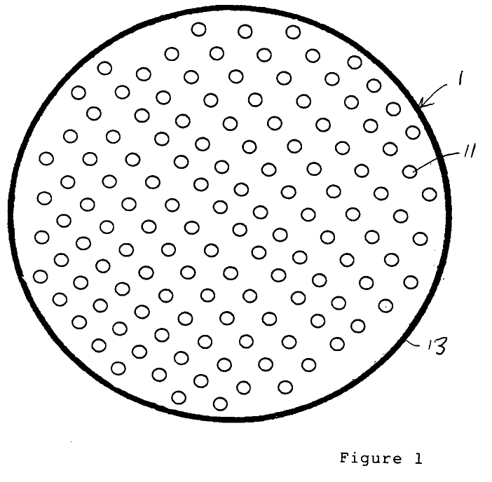

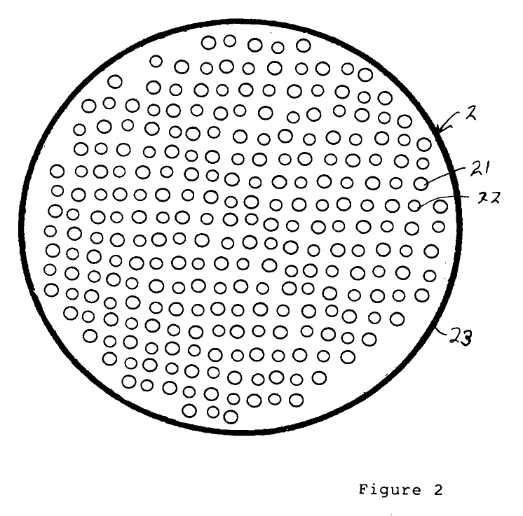

A front plan view of a prior art traffic light 1 is shown in FIG. 1. Arrayed LEDs 11 are contained within a case 13.

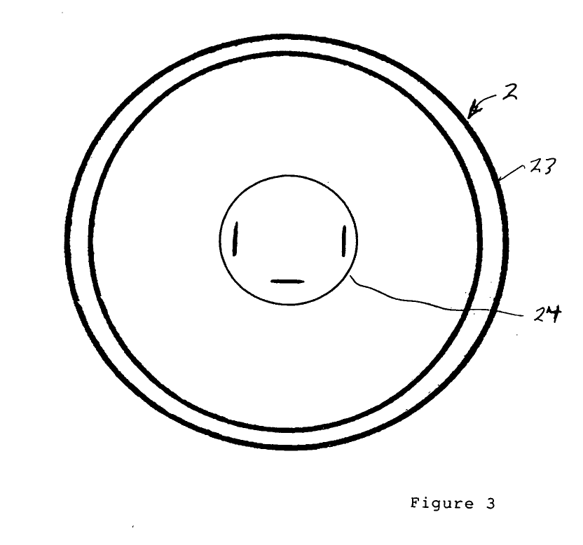

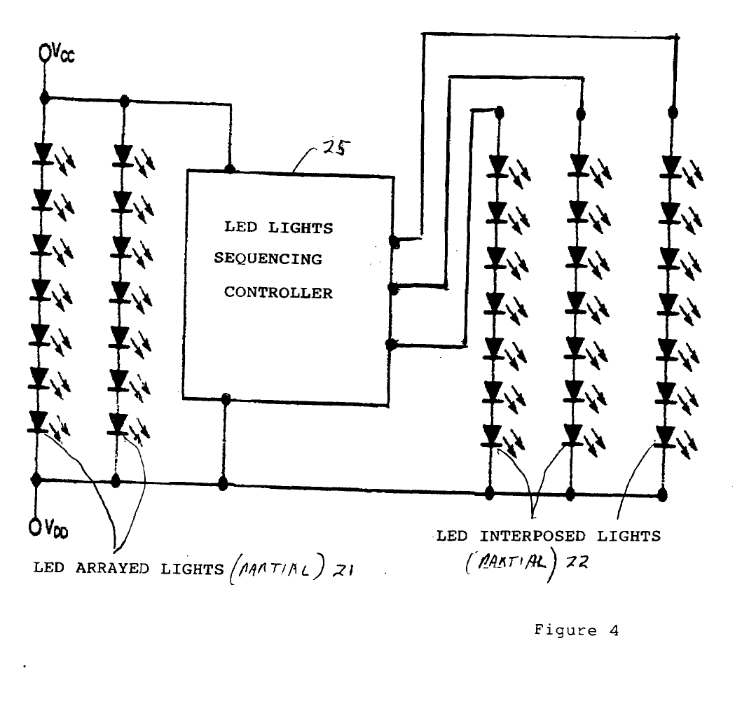

A preferred embodiment of a traffic light 2 in accordance with the present invention, showing original LEDs 21 plus additional, interspersed, arrayed LEDs 22 (over the prior art light 1 previously seen in FIG. 1) is shown in front plan view in FIG. 2, and in rear plan view in FIG. 3. A plug 24 is shown upon the rear in FIG. 3.

A block electrical schematic diagram of the exemplary traffic light 2 in accordance with the present invention, previously seen in FIGS. 2 and 3, is shown in FIG. 4. The LED LIGHTS SEQUENCING CONTROLLER 24 activates the LEDs 21, or which Led ARRAYED LIGHTS (PARTIAL) 21 are shown, to be on constantly, or at least for the duration of the illumination period, For example, if the LEDs 21 (and 22) are part of the RED section of a normal three-color stop light, then the LEDs 21 (PARTIAL) will be on for the duration the red illuminating period of the traffic signal.

In accordance with the present invention the LED LIGHTS SEQUENCING CONTROLLER 24 also serves to periodically activate certain ones of the LEDs 22, or which LED ARRAYED LIGHTS (PARTIAL) 22 are shown, to be on for a part of the duration of the illumination period. For example, if the LEDs 22 are part of the RED section of a normal three-color stop light, then some of these LEDs 22 (PARTIAL) will be on for a first part of the red illuminating period of the traffic signal, others will be on for a second part of the red illuminating period of the traffic signal, and still others will be on for a third and final part of the red illuminating period of the traffic signal.

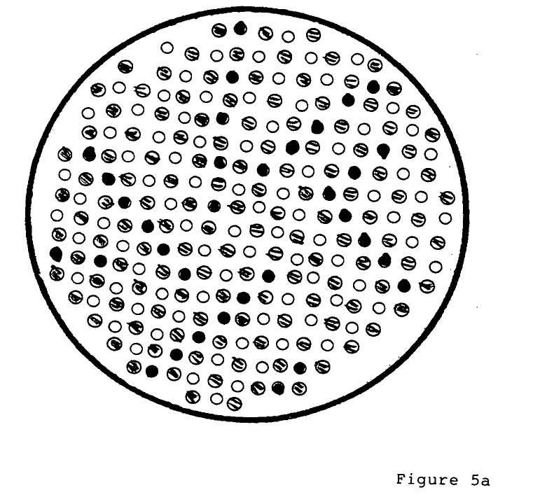

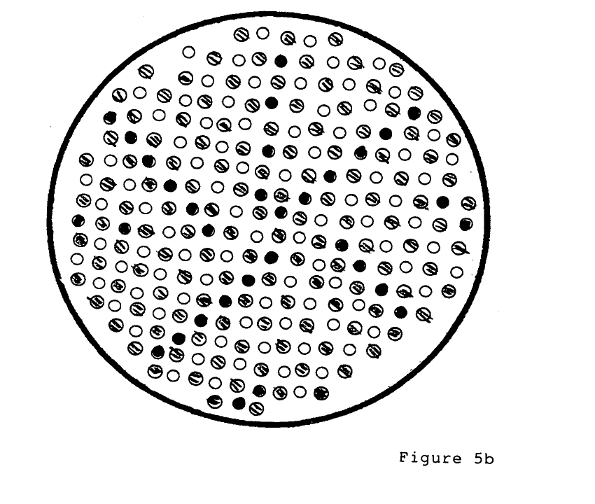

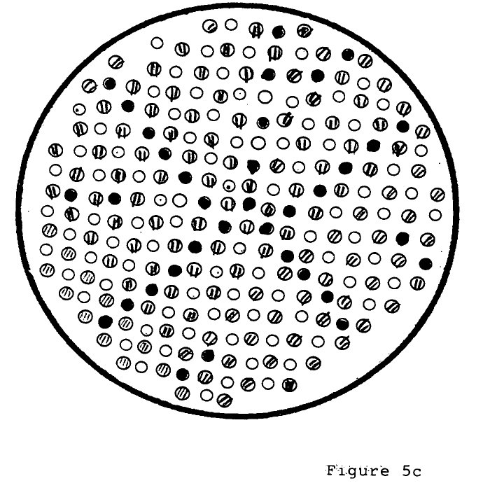

For example, potential illumination patterns so generated are shown in FIG. 5, consisting of FIGS. 5a through 5c. The constantly illuminated LEDs 21 are cross-hatched. The first-illuminated portion of the periodically-illuminated LEDs 22 is shown shaded in FIG. 5a —although, or course, all LEDs will be recognized to be emitting light, and to be essentially individually indistinguishable when illuminated, Similarly, a successive portion of periodically-illuminated LEDs 22 is shown shaded in FIG. 5b, and a final portion in FIG. 5c,

The net display effect of cycling through the illustrated three portions of the LEDs 22, while the LEDs 21 remain constantly illuminated, is like as to a rotating pinwheel that, while producing a constant illumination, nonetheless shows a clockwise rotating component.

Still other possible patterns may appear on an traffic signal lights in accordance with the present invention. For example, the variable second light emission nay give the appearance of expanding rings. For example, the variable second light emission gives the appearance of successive random patterns. In each and in all cases the variable second light emission may have a cycle period of, in particular, from 8 to 10 seconds.

LED-type traffic signal lights may, in particular, be retrofitted with the LED LIGHTS SEQUENCING CONTROLLER of FIG. 4, realizing the functionality of the present invention.

According to these variations, and still others within the skill of a practitioner of the art of designing electrically sequenced lights, the present invention should be considered in accordance with the following claims, only, and not solely on accordance with those embodiments within which the invention has been taught.

What is claimed is:

1. A traffic control light presenting from time to time and at times
a first, constant, light emission; accompanied by
a second light emission that is in any of time, space, hue, pitch (frequency) and chroma variable.

2. The traffic control light according to claim 1
wherein the constant first light emission is produced by arrayed substantial point first light sources; and
wherein the variable second light emission of produced by arrayed substantial point second light sources physically interspersed with the first light sources.

3. The traffic control light according to claim 1
wherein the constant first light emission is produced by arrayed substantial point first LED light sources; and
wherein the variable second light emission of produced by arrayed substantial point second LED light sources physically interspersed with the first light sources.

4. The traffic control light according to claim 1
wherein the variable second light emission gives the appearance of rotation.

5. The traffic control light according to claim 4
wherein the variable second light emission has a rotational cycle period of from 8 to 10 seconds.

6. The traffic control light according to claim 1
wherein the variable second light emission gives the appearance of expanding rings.

7. The traffic control light according to claim 6
wherein the variable second light emission has a expansion cycle period of from 8 to 10 seconds.

8. The traffic control light according to claim 1
wherein the variable second light emission gives the appearance of successive random patterns.

9. The traffic control light according to claim 9
wherein the variable second light emission has a cycle period of from 8 to 10 seconds.
